(19) United States
(12) Patent Application Publication
(10) Pub. No.: US 2025/0015457 A1
(43) Pub. Date: Jan. 9, 2025

(54) POWER BATTERY

(71) Applicant: SAVEWO HONG KONG LIMITED, HONG KONG (CN)

(72) Inventor: ZHEN DING, HONG KONG (CN)

(21) Appl. No.: 18/735,703

(22) Filed: Jun. 6, 2024

(30) Foreign Application Priority Data
Jul. 3, 2023 (CN) 202321711703.6

(51) Int. Cl. H01M 50/548; H01M 50/55; H01M 50/567

(52) U.S. Cl. CPC H01M 50/548; H01M 50/55; H01M 50/567

(57) ABSTRACT

The present application discloses a power battery including a body and a wiring assembly including two groups of wiring piles respectively arranged at two sides of the body. The two groups of wiring piles are symmetrically arranged with respect to a central axis of the body, and each of the two groups of wiring piles includes a positive wiring post and a negative wiring post. The power battery can meet the requirements of different electrical apparatuses for positions of positive and negative wiring posts of the wiring pile so that the power battery with the same parameters is compatible with all the electrical apparatuses matched with the parameters, thereby enriching the use mode of the power battery and broadening the compatibility of the power battery.

### TECHNICAL FIELD

The present application relates to the technical field of batteries, and in particular, relates to a power battery.

### BACKGROUND

With the rise of new energy sources in the world, more and more vehicles or toys are powered by batteries, and this makes power batteries widely used. The working principle of the power battery is as follows: the electrodes in the battery core participate in electrochemical reactions to convert chemical energy into electrical energy, and then lead-out wires of tabs are electrically connected with external wiring assemblies so as to supply power to the external circuit. The wiring assembly of the power battery includes a wiring pile, which is usually arranged on the top surface of the battery body and close to one side, so that the wiring pile is closer to external wiring terminals and convenient for wiring. The wiring pile includes a positive wiring pile and a negative wiring pile which correspond to a positive wiring terminal and a negative wiring terminal of the external power supply circuit respectively.

Since the types and models of existing electrical apparatuses are miscellaneous, and positions of positive and negative terminals of power supply lines of different electrical apparatuses are also different, it requires the electrical apparatuses to be matched with the positions of the positive and negative electrodes of batteries. Especially for automobiles, toys and other apparatuses that need power batteries, it often happens that the battery parameters are matched with the electrical apparatus but the positions of the positive and negative wiring piles are not matched so that the power battery is incompatible with the electrical apparatus, which seriously affects the compatibility of the power batteries and greatly restricts the use mode of the batteries and the objects to which the batteries are applicable.

### SUMMARY

An embodiment of the present application aims to provide a power battery, which can solve the technical problem of poor compatibility of power batteries in the prior art.

The embodiment of the present application adopts the following technical solutions to solve the aforesaid technical problem.

The present application discloses a power battery, which includes:
a body;
a wiring assembly including two groups of wiring piles respectively arranged at two sides of the body, wherein the two groups of wiring piles are symmetrically arranged with respect to a central axis of the body, and each of the two groups of wiring piles includes a positive wiring post and a negative wiring post.

By providing a group of wiring piles at each of both sides of the body, the two groups of wiring piles are symmetrically distributed about a central axis of the body, so that positions of the two groups of wiring piles can be interchanged and positions of the positive wiring post and the negative wiring post are also interchanged accordingly simply by rotating the body by 180 degrees. This can meet the requirements of different electrical apparatuses for positions of positive and negative wiring posts of the wiring pile so that the power battery with the same parameters is compatible with all the electrical apparatuses matched with the parameters, thereby enriching the use mode of the power battery and broadening the compatibility of the power battery.

In an embodiment, the body includes a cathode tab and an anode tab, the two positive wiring posts are electrically connected with the cathode tab and the two negative wiring posts are electrically connected with the anode tab.

By electrically connecting the two positive wiring posts with the cathode tab and the two negative wiring posts with the anode tabs respectively, power supply can be realized when any of the two groups of wiring piles is connected with an external power supply circuit.

In an embodiment, the positive wiring post and the negative wiring post are respectively arranged at two ends of the body. Arranging the positive wiring post and the negative wiring post respectively at two ends of the body not only conforms to the wiring habits of most electrical apparatuses, but also avoids the creepage between the positive and negative electrodes.

In an embodiment, the wiring assembly further includes a positive bolted cap only adapted to the positive wiring post and a negative bolted cap only adapted to the negative wiring post.

By making the positive bolted cap only adapted to the positive wiring post and the negative bolted cap only adapted to the negative wiring post, it is possible to prevent the wrong connection of the positive and negative electrodes caused by misuse of the positive bolted cap and the negative bolted cap.

In an embodiment, there is a certain difference between the size of the positive and negative bolted caps. By setting the positive and negative bolted caps to different sizes and in combination with the fact that the positive bolted cap is only matched with the positive wiring post and the negative bolted cap is only matched with the negative wiring post, the matching with the positive wiring post and the negative wiring post can be completed quickly by means of the size difference between the positive and negative bolted caps, thereby facilitating the wiring of the positive and negative electrodes and avoiding wiring errors.

In an embodiment, the positive bolted cap is provided with a first internal thread, the positive wiring post is provided with a first external thread adapted to the first internal thread, the negative bolted cap is provided with a second internal thread, and the negative wiring post is provided with a second external thread adapted to the second internal thread.

In this way, threaded connection between the positive bolted cap and the positive wiring post is realized through the first internal thread and the first external thread, and wiring terminals are clamped and fastened on the positive wiring post and the negative wiring post by screwing the positive bolted cap and the negative bolted cap, thereby achieving good electrical contact and being convenient for assembly and disassembly.

In another embodiment, each group of wiring piles further includes a positive wiring hole and a negative wiring hole fixedly provided on the surface of the body, wherein the positive wiring post is only adapted to the positive wiring hole and the negative wiring post is only adapted to the negative wiring hole, the positive bolted cap is provided with a first via through which only a tail end of the positive wiring post passes, and the negative bolted cap is provided with a second via through which only a tail end of the negative wiring post passes.

Through the one-to-one matching structure between the positive wiring post and the positive wiring hole, the positive wiring post is prevented from being wrongly connected to the negative wiring hole, and then, through the one-to-one matching between the positive wiring post and the first via, the positive wiring post is prevented from being wrongly matched with the negative bolted cap. In this way, rapid wiring is realized through the unique matching relationship between the positive wiring post, the positive wiring hole and the positive bolted cap, and wiring errors of the positive and negative electrodes is avoided. Similarly, through the one-to-one matching structure between the negative wiring post and the negative wiring hole, the negative wiring post is prevented from being wrongly connected to the positive wiring hole, and then, through the one-to-one matching between the negative wiring post and the second via, the negative wiring post is prevented from being wrongly matched with the positive bolted cap. In this way, rapid wiring is realized through the unique matching relationship between the negative wiring post, the negative wiring hole and the negative bolted cap, and wiring errors of the positive and negative electrodes is avoided.

In an embodiment, each group of wiring piles further includes a positive wiring hole and a negative wiring hole fixedly provided on the surface of the body, the positive wiring post is only adapted to the positive wiring hole, the negative wiring post is only adapted to the negative wiring hole, the positive bolted cap is integrally formed with the positive wiring post, and the negative bolted cap is integrally formed with the negative wiring post. In an embodiment, the surface of the positive wiring post is provided with a third external thread, the positive wiring hole is provided with a third internal thread adapted to the third external thread; the surface of the negative wiring post is provided with a fourth external thread, and the negative wiring hole is provided with a fourth internal thread adapted to the fourth external thread.

In this way, threaded connection between the positive wiring post and the positive wiring hole is realized through the third internal thread and the third external thread, and threaded connection between the negative wiring post and the negative wiring hole is realized through the fourth internal thread and the fourth external thread. The mismatch of the positive wiring post and the negative wiring post is avoided because different threads cannot be engaged, and at the same time, the threaded connection is convenient for assembly and disassembly, and it ensures good electrical contact between the wiring posts and the wiring holes.

In an embodiment, the positive wiring post is a countersunk bolt, the external diameter of a head of the positive wiring post is larger than the internal diameter of the first via, the negative wiring post is a countersunk bolt, and the external diameter of a head of the negative wiring post is larger than the internal diameter of the second via.

By adopting the countersunk bolt structures for the positive wiring post and the negative wiring post, the positive bolted cap is prevented from falling off from the head of the positive wiring post, and the negative bolted cap is also prevented from falling off from the head of the negative wiring post. By adopting the countersunk bolt structures, the heads of the positive wiring post and the negative wiring post may be buried on the top of the positive bolted cap and the negative bolted cap respectively, so that the surface of the wiring assembly is clean.

In an embodiment, both the positive wiring post and the negative wiring post are hexagon socket countersunk bolts. Adopting hexagon socket countersunk bolts for the positive wiring post and the negative wiring post is convenient for operation and replacement of parts.

### BRIEF DESCRIPTION OF THE DRAWINGS

One or more embodiments are exemplarily described with reference to pictures in corresponding attached drawings, and these exemplary descriptions are not intended to limit the embodiments. In the attached drawings, elements with the same reference numerals represent the similar elements, and unless otherwise stated, the pictures in the attached drawings are not intended to limit the scale.

FIG. 1 is a schematic structural diagram of a power battery according to an embodiment of the present application.

FIG. 2 is a diagram of an assembled power battery according to an embodiment of the present application.

FIG. 3 is a schematic structural diagram of a power battery according to another embodiment of the present application.

FIG. 4 is a diagram of an assembled power battery according to another embodiment of the present application.

FIG. 5 is a perspective cross-sectional view of a power battery according to another embodiment of the present application.

### REFERENCE NUMERALS OF DRAWINGS AND CORRESPONDING MEANINGS

Body 1, Tab 10, Front surface 11, Back surface 12, Top surface 13, Side surface 14, Bottom surface 15;
Wiring pile 2, Positive wiring post 21, Negative wiring post 22, Positive bolted cap 23, First via 230, Negative bolted cap 24, Second via 240, Positive wiring hole 25, Negative wiring hole 26.

### DETAILED DESCRIPTION

In order to facilitate the understanding of the present application, the present application will be described in more detail hereinafter with reference to the attached drawings and specific embodiments. It shall be noted that, when an element is said to be “fixed” to another element, it may be directly fixed on the other element, or there may be one or more intervening elements therebetween. When an element is said to be “connected” to another element, it may be directly connected to the other element, or there may be one or more intervening elements therebetween. Terms such as “upper”, “lower”, “inside”, “outside”, “vertical” and “horizontal” used in this specification indicate orientation or positional relationships based on the orientation or positional relationships shown in the attached drawings, and those terms are only provided for the convenience of describing the present application and simplifying the description, and do not indicate or imply that the devices or elements referred to must have a specific orientation or must be constructed and operated in a specific orientation, so these terms should not be construed as limitations to the present application. In addition, terms such as “first” and “second” are only used for descriptive purposes and should not be construed as indicating or implying relative importance. Words such as “including” or “containing” and similar words mean that the elements or objects appearing before the words cover the elements or objects and equivalents thereof listed after the word, without excluding other elements or objects. Words such as “connection” or “communication” and similar words are not limited to physical or mechanical connection, but may include electrical connection either direct or indirect. Unless otherwise defined, “parallel”, “vertical” and “identical” or the like used in the embodiments of the present application include both “parallel”, “vertical” and “identical” or the like in a strict sense and “approximately parallel”, “approximately vertical” and “approximately identical” or the like containing certain errors. For example, the term “approximately” mentioned above may mean that the difference between the compared objects is within 10% or 5% of an average value of the compared objects. When the number of a component or element is not specified in the following description of the embodiment of the present application, it means that the number of the component or element may be one or more, or the number of the component or the element may be construed as at least one. “At least one” means one or more, and “multiple” means at least two.

Unless otherwise defined, all technical and scientific terms used in this specification have the same meaning as commonly understood by those skilled in the art to which the present application belongs. The terms used in the specification of the present application are only for the purpose of describing specific embodiments and are not intended to limit the present application. The term “and/or” as used in this specification includes any and all combinations of one or more related items listed.

In addition, technical features involved in different embodiments of the present application described below may be combined with each other as long as they do not conflict with each other. Obviously, the embodiments described herein are only a part but not all of the embodiments of the present application. Based on the described embodiments of the present application, all other embodiments obtained by those of ordinary skill in the art without creative labor shall all belong to the scope claimed in the present application.

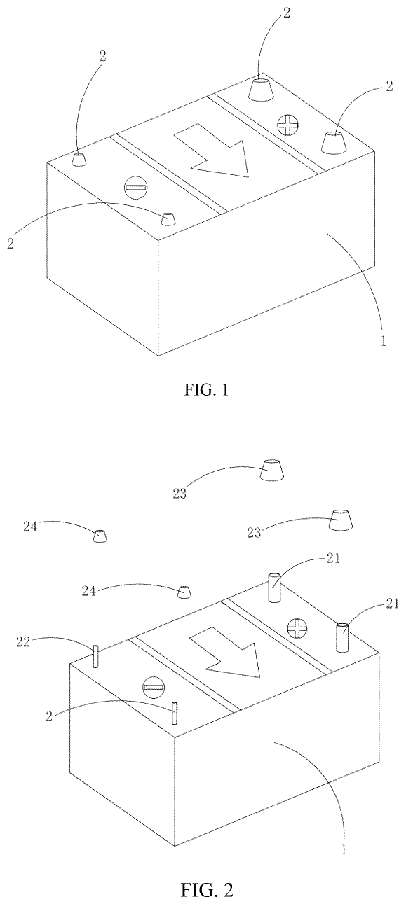

As shown in FIG. 1 to FIG. 3, a power battery disclosed in the present application includes a body 1 and a wiring assembly arranged on the surface of the body 1. The wiring assembly may be arranged on the top surface of the body 1 or arranged on the side surface of the body 1. This embodiment and the attached drawings take the case where the wiring assembly is arranged on the top surface of the body 1 as an example for illustration. In this embodiment, the wiring assembly includes two groups of wiring piles 2 respectively arranged on two sides of the body 1, and the two groups of wiring piles 2 are symmetrically arranged with respect to a central axis of the body. Each group of wiring piles 1 includes a positive wiring post 21 for electrical connection with a positive wiring terminal of an external circuit and a negative wiring post 22 for electrical connection with a negative wiring terminal of an external circuit. In this embodiment, two sides and two ends refer to two directions perpendicular to each other along the length and width of the body 1. In order to facilitate the wiring of the power circuit of the electrical apparatus, the wiring pile of the power battery is usually arranged on the top surface of the body 1 at the edge near the side surface, which will shorten the wiring length of the power circuit and facilitate wiring and management. Therefore, in this embodiment, the two groups of wiring piles 2 are symmetrically arranged on two sides of the body 1 with respect to a central axis of the body 1.

By providing a group of wiring piles 2 at each of both sides of the body 1, the two groups of wiring piles 2 are symmetrically distributed about a central axis of the body, so that positions of the two groups of wiring piles 2 can be interchanged and positions of the positive wiring post 21 and the negative wiring post 22 are also interchanged accordingly simply by rotating the body by 180 degrees. This can meet requirements of different electrical apparatus for positions of the positive and negative wiring posts of the wiring pile 2, so that the power battery with the same parameters is compatible with all the electrical apparatuses matched with the parameters, thereby enriching the use mode of the power battery and broadening the compatibility of the power battery.

The body 1 includes an anode tab and a cathode tab, wherein the cathode tab is used as the positive electrode of the power supply and the anode tab is used as the negative electrode of the power supply. The two positive wiring posts 21 are electrically connected with the cathode tab from both sides of the body 1, and similarly, the two negative wiring posts 22 are electrically connected with the anode tab from both sides of the body 1. By electrically connecting the two positive wiring posts 21 with the cathode tab and the two negative wiring posts 22 with the anode tabs respectively, power supply can be realized when any of the two groups of wiring piles 2 is connected with an external power supply circuit.

As shown in FIG. 2, the positive wiring post 21 and the negative wiring post 22 are respectively arranged at two ends of the body. That is, the two positive wiring posts 21 and the two negative wiring posts 22 are distributed on the top surface of the body 1 near four corners, wherein the two positive wiring posts 21 are located at two sides of the same end of the body 1, and the two negative wiring posts 22 are located at two sides of the other end of the body 1. Arranging the positive wiring post 21 and the negative wiring post 22 at two ends of the body 1 respectively not only conforms to the wiring habits of most electrical apparatuses, but also avoids the creepage between the positive and negative electrodes.

As shown in FIG. 1 to FIG. 4, the wiring assembly includes a positive bolted cap 23 only adapted to the positive wiring post 21 and a negative bolted cap 24 only adapted to the negative wiring post 22. The positive bolted cap 23 being only adapted to the positive wiring post 21 means that the positive bolted cap 23 corresponds to the positive wiring post 21 in one-to-one correspondence and cannot be assembled on the negative wiring post 22. Similarly, the negative bolted cap 24 being only adapted to the negative wiring post 22 means that the negative bolted cap 24 corresponds to the negative wiring post 22 in one-to-one correspondence and cannot be assembled on the positive wiring post 21.

By making the positive bolted cap 23 only adapted to the positive wiring post 21 and the negative bolted cap 22 only adapted to the negative wiring post 24, it is possible to prevent the misuse of the positive bolted cap 23 and the negative bolted cap 24, and then wrong connection between the positive and negative electrodes can be avoided by differentiating the positive bolted cap 23 from the negative bolted cap 24.

In this embodiment, as shown in FIG. 1 to FIG. 4, there is a certain difference in sizes of the positive bolted cap 23 and the negative bolted cap 24. Specifically, the height of the positive bolted cap 23 and the outer diameters of both ends of the positive bolted cap 23 are all greater than those of the negative bolted cap 24. Of course, other ways for differentiation may also be adopted. For example, the positive bolted cap 23 and the negative bolted cap 24 are provided in different shapes, e.g., the positive bolted cap 21 is provided in the shape of a frustum of cone, while the negative bolted cap 24 is provided in the shape of a cylinder.

In this embodiment, by setting the positive bolted cap 23 and the negative bolted cap 24 to different sizes and in combination with the fact that the positive bolted cap 23 is only matched with the positive wiring post 21 and the negative bolted cap 24 is only matched with the negative wiring post 22, the correct matching with the positive wiring post 21 and the negative wiring post 22 can be completed quickly by means of the size difference between the positive bolted cap 23 and the negative bolted cap 24, thereby facilitating the wiring of the positive and negative electrodes and avoiding wiring errors of the positive and negative electrodes.

As shown in FIG. 2, the positive bolted cap 23 is provided with a first internal thread, the positive wiring post 21 is provided with a first external thread adapted to the first internal thread, the negative bolted cap 22 is provided with a second internal thread, and the negative wiring post 22 is provided with a second external thread adapted to the second internal thread. That is, the first internal thread cannot be engaged with the second external thread, and the second internal thread cannot be engaged with the first external thread.

In this way, threaded connection between the positive bolted cap 23 and the positive wiring post 21 is realized through the first internal thread and the first external thread, and wiring terminals of the power supply circuit are clamped and fastened on the positive wiring post 21 and the negative wiring post 22 correspondingly by screwing the positive bolted cap 23 and the negative bolted cap 24, thereby achieving good electrical contact and being convenient for assembly and disassembly.

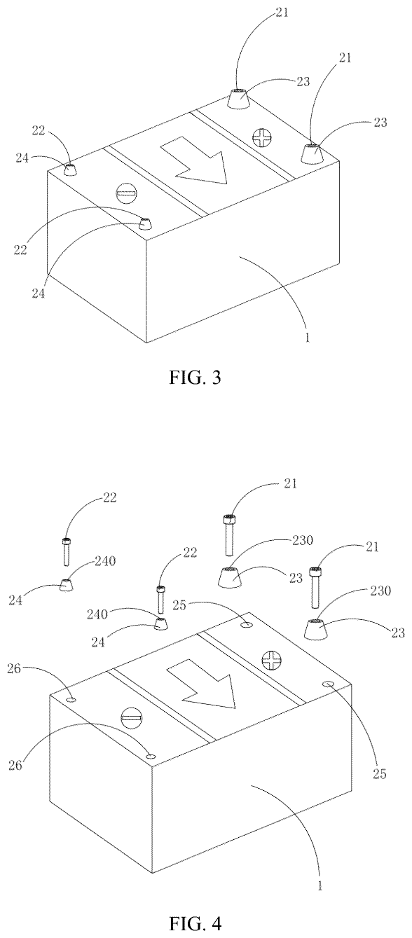

In other embodiments of the present application, the positive wiring post 21 and the negative wiring post 22 may also respectively pass through the positive bolted cap 23 and the negative bolted cap 24 and fix the positive bolted cap 23 and the negative bolted cap 24 on the top surface of the body 1, so as to realize the fixed connection of the positive wiring post 21 and the negative wiring post 22 with the positive bolted cap 23 and the negative bolted cap 24. Specifically, as shown in FIG. 3 and FIG. 4, each group of wiring piles 2 further includes a positive wiring hole 25 and a negative wiring hole 26 fixedly provided on the surface of the body 1, wherein the positive wiring post 21 is only adapted to the positive wiring hole 25, the negative wiring post 22 is only adapted to the negative wiring hole 26, the positive bolted cap 23 is provided with a first via 230 through which only a tail end of the positive wiring post 21 passes, and the negative bolted cap 24 is provided with a second via 240 through which only a tail end of the negative wiring post 22 passes. During assembly, the positive wiring post 21 is inserted downward into the first via 230 from the top of the positive bolted cap 23, then the positive wiring post 21 extends out from the bottom of the positive bolted cap 23 and is fixedly connected with the positive wiring hole 25 after passing through the wiring terminal of the power supply circuit. Similarly, the negative wiring post 22 is inserted downward into the second via 240 from the top of the negative bolted cap 24, and then the negative wiring post 22 extends out from the bottom of the negative bolted cap 24 and is fixedly connected with the positive wiring hole 25 after passing through the wiring terminal of the power supply circuit.

Through the one-to-one matching structure between the positive wiring post 21 and the positive wiring hole 25, the positive wiring post 21 is prevented from being wrongly connected to the negative wiring hole 26, and then, through the one-to-one matching between the positive wiring post 21 and the first via 230, the positive wiring post is prevented from being wrongly matched with the negative bolted cap. In this way, rapid wiring is realized through the unique matching relationship between the positive wiring post, the positive wiring hole and the positive bolted cap, and wiring errors of the positive and negative electrodes is avoided. Similarly, through the one-to-one matching structure between the negative wiring post and the negative wiring hole, the negative wiring post is prevented from being wrongly connected to the positive wiring hole, and then, through the one-to-one matching between the negative wiring post and the second via, the negative wiring post is prevented from being wrongly matched with the positive bolted cap. In this way, rapid wiring is realized through the unique matching relationship between the negative wiring post, the negative wiring hole and the negative bolted cap, and wiring errors of the positive and negative electrodes is avoided.

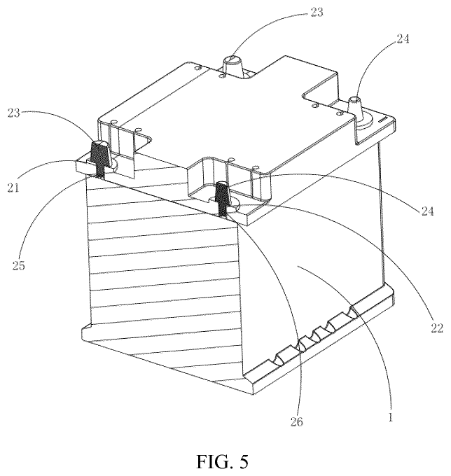

As shown in FIG. 5, in another embodiment of the present application, the positive bolted cap 23 and the positive wiring post 21 may also be formed into an integral structure, the corresponding negative bolted cap 24 and the negative wiring post 22 may be formed into an integral structure, and at the same time, the positive wiring post 21 is only adapted to the positive wiring hole 25, and the negative wiring post 22 is only adapted to the negative wiring hole 26. In this way, the positive bolted cap 23 is formed integrally with the positive wiring post 21, and the negative bolted cap 24 is formed integrally with the negative wiring post 22, so that the wirings of the positive and negative electrodes can be prevented from being reversed, and at the same time, it is unnecessary to combine the positive bolted cap 23 with the positive wiring post 21 and combine the negative bolted cap 24 with the negative wiring post 22, so that the wiring operation is more convenient. In addition, such a structure can reduce the contact resistance of the wiring pile, reduce the voltage drop at the wiring pile, and avoid the excessive temperature of the wiring pile which otherwise would affect the normal use of the apparatus.

As shown in FIG. 3 and FIG. 4, the surface of the positive wiring post 21 is provided with a third external thread, and the positive wiring hole 25 is provided with a third internal thread adapted to the third external thread. Similarly, the surface of the negative wiring post 22 is provided with a fourth external thread, and the negative wiring hole 26 is provided with a fourth internal thread adapted to the fourth external thread. The third external thread is only adapted to the third internal thread and cannot be engaged with the fourth internal thread, and similarly, the fourth external thread is only adapted to the fourth internal thread and cannot be engaged with the third internal thread.

In this way, threaded connection of the positive wiring post 21 and the positive wiring hole 25 is realized by the third internal thread and the third external thread, and threaded connection between the negative wiring post 22 and the negative wiring hole 26 is realized by the fourth internal thread and the fourth external thread. The mismatch of the positive wiring post 21 and the negative wiring post 22 is avoided because different threads cannot be engaged, and at the same time, the threaded connection is convenient for assembly and disassembly and it ensures good electrical contact between the wiring posts and the wiring holes.

As shown in FIG. 4, both the positive wiring post 21 and the negative wiring post 22 are countersunk bolts, the outer diameter of the head of the positive wiring post 21 is larger than the inner diameter of the first via 230, and the outer diameter of the head of the negative wiring post 22 is larger than the inner diameter of the second via 240. The positive wiring post 21 and the negative wiring post 22 may adopt hexagon socket countersunk bolts or triangle socket countersunk bolts, which is convenient for operation and replacement of parts.

In this way, by adopting the countersunk bolt structures for the positive wiring post 21 and the negative wiring post 22, the positive bolted cap 23 is prevented from falling off from the head of the positive wiring post 21, and the negative bolted cap 24 is also prevented from falling off from the head of the negative wiring post 22. By adopting the countersunk bolt structures, the heads of the positive wiring post 21 and the negative wiring post 22 may be buried on the top of the positive bolted cap 23 and the negative bolted cap 24 respectively, so that the surface of the wiring assembly is clean.

Finally it shall be noted that, the above embodiments are only used to describe but not to limit the technical solutions of the present application; and under the concept of the present application, technical features of the above embodiments or different embodiments may also be combined with each other, the steps may be implemented in an arbitrary order, and many other variations in different aspects of the present application described above are possible although, for purpose of simplicity, they are not provided in the details. Although the present application has been detailed with reference to the above embodiments, those of ordinary skill in the art shall appreciate that modifications can still be made to the technical solutions disclosed in the above embodiments or equivalent substations may be made to some of the technical features, and the corresponding technical solutions will not essentially depart from the scope of the technical solutions of the embodiments of the present application due to such modifications or substations.

What is claimed is:

1. A power battery, comprising:
a body;
a wiring assembly comprising two groups of wiring piles respectively arranged at two sides of the body, wherein the two groups of wiring piles are symmetrically arranged with respect to a central axis of the body, and each of the two groups of wiring piles comprises a positive wiring post and a negative wiring post.

2. The power battery according to claim 1, wherein the body comprises a cathode tab and an anode tab, the two positive wiring posts are electrically connected with the cathode tab, and the two negative wiring posts are electrically connected with the anode tab.

3. The power battery according to claim 2, wherein the positive wiring post and the negative wiring post are respectively arranged at two ends of the body.

4. The power battery according to claim 1, wherein the wiring assembly further comprises a positive bolted cap adapted to be used exclusively with the positive wiring post and a negative bolted cap adapted to be used exclusively with the negative wiring post.

5. The power battery according to claim 4, wherein the positive bolted cap is provided with a first internal thread, the positive wiring post is provided with a first external thread adapted to the first internal thread, the negative bolted cap is provided with a second internal thread, and the negative wiring post is provided with a second external thread adapted to the second internal thread.

6. The power battery according to claim 4, wherein the positive bolted cap and the negative bolted cap differ in size.

7. The power battery according to claim 4, wherein each of the two groups of wiring piles further comprises a positive wiring hole and a negative wiring hole fixedly provided on the surface of the body, wherein the positive wiring post is adapted to be used exclusively with the positive wiring hole and the negative wiring post is adapted to be used exclusively with the negative wiring hole, the positive bolted cap is provided with a first via through which only a tail end of the positive wiring post passes; and the negative bolted cap is provided with a second via through which only a tail end of the negative wiring post passes.

8. The power battery according to claim 4, wherein each of the two groups of wiring piles further comprises a positive wiring hole and a negative wiring hole fixedly provided on the surface of the body, the positive wiring post is adapted to be used exclusively with the positive wiring hole, the negative wiring post is adapted to be used exclusively with the negative wiring hole, the positive bolted cap is integrally formed with the positive wiring post, and the negative bolted cap is integrally formed with the negative wiring post.

9. The power battery according to claim 7, wherein the surface of the positive wiring post is provided with a third external thread, the positive wiring hole is provided with a third internal thread adapted to the third external thread; the surface of the negative wiring post is provided with a fourth external thread, and the negative wiring hole is provided with a fourth internal thread adapted to the fourth external thread.

10. The power battery according to claim 7, wherein the positive wiring post is a countersunk bolt, the external diameter of a head of the positive wiring post is larger than the internal diameter of the first via, the negative wiring post is a countersunk bolt, and the external diameter of a head of the negative wiring post is larger than the internal diameter of the second via.
